(19) United States
(12) Patent Application Publication
(10) Pub. No.: US 2026/0106225 A1
(43) Pub. Date: Apr. 16, 2026

(54) HIGH POWER HYBRID SILICON ANODE WITH EXTREME FAST CHARGING

(71) Applicant: Eflion Power, Inc., Framingham, MA (US)

(72) Inventors: Yingnan Dong, Wayland, MA (US); Xiaobo Li, Richland, WA (US); Ting Liu, Wilmington, MA (US); Jizong Zhang, Henan (CN)

(21) Appl. No.: 19/354,886

(22) Filed: Oct. 10, 2025

Related U.S. Application Data
(63) Continuation-in-part of application No. 19/276,353, filed on Jul. 22, 2025.
(60) Provisional application No. 63/705,815, filed on Oct. 10, 2024.

(51) Int. Cl. H01M 10/0569; H01M 4/36; H01M 4/525; H01M 4/587; H01M 50/434; H01M 50/451; H01M 50/491

(52) U.S. Cl. CPC H01M 10/0569; H01M 4/366; H01M 4/525; H01M 4/587; H01M 50/434; H01M 50/451; H01M 50/491; H01M 2300/0034; H01M 2300/0042

(57) ABSTRACT

A lithium battery with a battery electrolyte having a plurality of linear alkyl carbonates, a fluorinated solvent, and an acetate. The volume percentages of these electrolyte components meet one or more relational conditions.

### CROSS-REFERENCE TO RELATED APPLICATION

This application is a continuation-in-part of U.S. patent application Ser. No. 19/276,353 filed on Jul. 22, 2025, which claims benefit to U.S. Provisional Application No. 63/705,815 filed on Oct. 10, 2024. The entire content of these applications are incorporated herein by reference in their entirety.

### FIELD OF THE INVENTION

The present invention generally relates to lithium ion batteries, and more particularly to a lithium battery having a hybrid anode comprising silicon, graphite and hard carbon active materials.

### SUMMARY OF THE INVENTION

The invention describes a battery with a battery electrolyte having a plurality of linear alkyl carbonates, a fluorinated solvent, and an acetate. In certain aspects of the invention, the volume percentages of these electrolyte components meet one or more relational conditions including: the combined volume percent of the acetate and fluorinated solvent are between or equal to fifty percent (50%) and seventy percent (70%); the volume ratio of the acetate to the fluorinated solvent is equal to or greater than 0.8 and equal to or less than 6.0; the volume of the fluorinated solvent is equal to or less than twenty percent (20%); and the volume percentage of the acetate is equal to or greater than 20%. In some aspects the battery electrolyte meets two, three of all four relational conditions.

In an aspect the battery electrolyte comprises linear alkyl carbonates having a methyl group, a dimethyl group or both a methyl and dimethyl group.

In a further aspect the acetate compound of the battery electrolyte is selected from the group consisting of methyl acetate, ethyl acetate and vinyl acetate.

In a further aspect the fluorinated solvent of the battery electrolyte is a carbonate, such as fluoroethylene carbonate.

The battery further comprises a negative electrode having from about 85 wt % to about 98 wt % of active materials in a first aspect and from about 5 wt % to about 100 wt % of an active material in a second aspect and from about 30 to 50 wt % of an active material in a further aspect.

In an aspect the active material of the negative electrode of the battery comprises silicon, or is selected from the group consisting of an active material comprising SiOₓ, an active material comprising silicon which is coated with a conductive carbon, an active material comprising carbon-encapsulated SiOₓ, and silicon carbide.

In an aspect the negative electrode of the battery comprises a composite of the active materials and the composite is distributed throughout the anode.

The battery further comprises a positive electrode or cathode having an active material comprising a nickel-rich lithium nickel manganese cobalt oxide, wherein the nickel-rich lithium nickel manganese cobalt oxide is approximately represented by the formula LiNiₓMn_{y}Co_{z}O₂, where x+y+z≈1, 0.80≤x, 0.025≤y≤0.1, 0.025≤z≤0.1. in a first aspect, or active material comprising a nickel-rich lithium nickel manganese cobalt oxide, wherein the nickel-rich lithium nickel manganese cobalt oxide is approximately represented by the formula LiNiₓMn_{y}Co_{z}O₂, where LiNiₓMn_{y}Co_{z}O₂, where x+y+z≈1, 0.6≤x, 0.025≤y≤0.2, 0.025≤z≤0.2.

The battery of further comprises a separator, and in aspect the separator is polymeric and has a porosity greater than 40% in a first aspect and the separator is ceramic coated in a further aspect.

In an aspect the battery electrolyte comprises at least one salt selected from a group consisting of LiPF₆, LiBF₄, LiFSI, and LiTFSI, wherein the electrolyte comprises a total concentration of generally 1-2M of the lithium salts.

In an aspect the battery electrolyte further comprises a combination of additives selected from a group comprising VC, FEC, DTD, PS, LiODFP, LiODFB, LiPO₂F₂, TMSP, flame retardant additives and compound of formula (11):

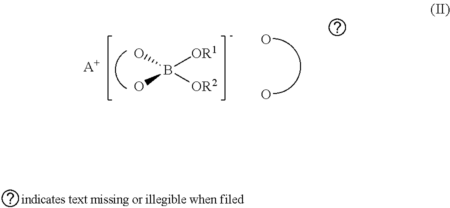

wherein: A⁺ is selected from the group consisting of Li⁺, Na⁺, K⁺, Cs⁺, and ammonium; wherein

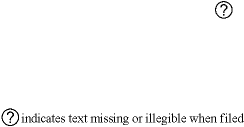

is a bidentate radical derived from a (hetero)aromatic 1,2-, 1,3- or 1,4-diol, from a (hetero)aromatic 1,2-, 1,3- or 1,4-dicarboxylic acid or from a (hetero)aromatic 1,2-, 1,3- or 1,4-hydroxycarboxylic acid by abstracting the two H atoms of pairs of adjacent OH groups; and R¹ and R² are independently selected from the group consisting of C₁ to C₁₀ alkyl, C₂ to C₁₀ alkenyl, C₂ to C₁₀ alkynyl, C₃ to C₁₀ cycloalkyl, and C₅ to C₁₄ (hetero)aryl, wherein alkyl, alkenyl, alkynyl, cycloalkyl, and (hetero)aryl may be substituted by one or more substituents selected from F, CN, and optionally fluorinated groups selected from a group consisting of C₁ to C₄ alkyl, C₂ to C₄ alkenyl, C₂ to C₄ alkynyl, phenyl, and benzyl.

The battery of any aspect results in a capacity of at least about 3 Ah, when operated at a charge cutoff voltage range of 4.2 to 4.5V, a discharge cutoff voltage range of 2.5 to 3.0V, and a minimum cycling rate range of 1 C to 10 C, or wherein the cell maintains at least 80% of its first cycle capacity after 500 cycles at 3 C discharge and 3 C charge rates at room temperature (25° C.), or wherein the cell discharge at 20 C rate retains at least 90% of capacity relative to cell discharge at 1 C rate at room temperature.

These and other features, advantages, and objects of the present invention will be further understood and appreciated by those skilled in the art by reference to the following specification, claims, and appended drawings.

### BACKGROUND OF THE INVENTION

However, the anodes of these cells are constrained by relatively low lithium diffusion at high rates. Graphite is characterized by a regular stacking of graphene layers with defined spacing, whereas hard carbon (HC) comprises randomly distributed turbostratic domains featuring curved graphene nanosheets and expanded interlayer spacing, alongside micropores within these structures. This unique structure of HC offers various lithium storage sites through expanded interlayer spacings, facilitating rapid solid-state lithium ion diffusion kinetics and storage. However, the complexity of HC structure contributes to challenges such as low initial Coulombic efficiency and significant voltage hysteresis, attributed to irreversible lithium uptake on pore surfaces and defect sites rather than within graphitic domains, which contribute to reversible capacity of HC. Due to these technical challenges, graphite remains the primary choice for lithium ion battery anodes and HC is not widely adopted in practical applications.

While graphite anodes are prone to irreversible Li plating during fast charging, they offer higher energy density. On the other hand, HC boasts superior rate capability.

A novel hybrid electrolyte design has been developed to address the use of high silicon content in the anode, which enables the creation of a lithium ion battery anode with enhanced high-power, higher energy density and improved cycling performance.

### BRIEF DESCRIPTION OF THE DRAWINGS

In the drawings:

FIG. 1 is graph showing the density of the anode compositions described in Example 3 per a range of active anode compositions;

FIG. 2 is a graph detailing the average charging voltage or charge energy/charge capacity for each cycle for the voltage range of 4.2V-2.5V with the cycling rate of 1 C symmetric, on both charge and discharge for coin cells described in Example 4;

FIG. 3 is a graph detailing the average discharge voltage or discharge energy/discharge capacity for each cycle for the voltage range of 4.2V-2.5V with the cycling rate of 1 C symmetric, on both charge and discharge for coin cells described in Example 4;

FIG. 4 is a graph detailing capacity retention during cycling performance for both of the 5 wt % HC and 0% HC full cells described in Example 4;

FIG. 5 is a graph showing average charge voltage at 10 C charge rate for the 5 wt % HC and control cells described in Example 4;

FIG. 6 is a graph showing average discharge voltage at 10 C discharge rate for the 5 wt % HC and control cells described in Example 4;

FIG. 7 is a graph showing 10 C capacity retention at 10 C charge and 10 C discharge compared to 1 C charge/discharge capacities for the 5 wt % HC and control cells described in Example 4.

FIG. 8 is a graph showing 8 Ah pouch cell cycling performance comparisons between 10 wt % HC and control cells described in Example 6.

FIG. 9 is a graph showing the capacity retention of cells with electrolyte examples 1 through 5 of Example 7 during room temperature cycling at 3 C/3 C rates.

### DETAILED DESCRIPTION OF THE PREFERRED EMBODIMENTS

Battery research has developed electrode compositions with high amounts of silicon based active material that provide improved cycling performance and associated high specific capacities. Improving the negative electrode material composite mixture by the addition of hard carbon enables higher power performance. In an aspect of the invention, Hard Carbon (HC) is integrated into a composite silicon anode at a weight ratio of about 5-10%, effectively replacing graphite. The total percentage of HC and graphite in the composite is approximately 70 wt. % or lower, combined with additional silicon content to provide an energy dense electrode. By incorporating HC at a relatively low level, the adverse effects on energy density, and voltage drop can be minimized.

Many metals, metal alloys, metal oxides, carbon materials and composites can incorporate lithium ions into their structure through intercalation, alloying or similar mechanisms. In the positive electrode of a lithium battery, the cathode generally comprises an active material that reversibly intercalates with lithium. For secondary lithium-ion batteries during charge, oxidation takes place in the cathode (positive electrode) where lithium ions are extracted and electrons are released. During discharge, reduction takes place in the cathode where lithium ions are inserted, and electrons are consumed. Similarly, during charge, reduction takes place at the anode (negative electrode) where lithium ions are taken up and electrons are consumed, and during discharge, oxidation takes place at the anode with lithium ions and electrons being released.

### Anode Materials

Elemental silicon as well as other silicon based active materials are used as negative electrode materials due to silicon's very high specific capacity. Elemental silicon forms an alloy with lithium, which can theoretically have a lithium content corresponding with more than 4 lithium atoms per silicon atom (e.g., Li_{4.4}Si). In comparison, the theoretical specific capacity of silicon is roughly 4000-4400 mAh/g, which can be compared to the theoretical capacity of about 370 mAh/g for graphite. Graphite may intercalate lithium at roughly 1 lithium atom for 6 carbon atoms (LiC₆). Silicon undergoes a very large volume change, in the range of two to three times of the original volume or greater, upon alloying with lithium, and the large volume changes have been correlated with a significant decrease in the cycling stability of such batteries.

In addition to elemental silicon, other types of silicon materials such as, silicon alloys, silicon suboxides, silicon composites and the like may be used as active anode materials and have low potential relative to lithium metal similar to graphite. Silicon suboxides, i.e., SiOₓ, x<2, or 0.1≤x≤1.9, are generally referred to as silicon oxide, which is not limited to silicon monoxide (SiO) unless specifically indicated. The silicon based active materials can comprise both elemental silicon and/or silicon suboxide as a primary active material. As with silicon, silicon oxide, can intercalate/alloy with lithium. The silicon oxide can incorporate a relatively large amount of lithium such that the material can exhibit a large specific capacity. The theoretical capacity of SiOₓ (0≤x≤2) (2200-3580 mAh g−1) is lower than that of Si. During the first cycle of a SiOₓ anode, Li₂O and Li₄SiO₄ are generated which can be used as a buffer matrix to form a stable SEI layer. The volume variation of SiOₓ particles (˜200%) is smaller than that of Si (˜400%). Porous SiOₓ can also accommodate its volume expansion during the lithiation process while providing excellent electrochemical performance. Commercial silicon-based material comprising SiOₓ which from some suppliers may be in a composite with carbon and silicon nanocrystals, is available from Lanxi Zhide Advanced Materials Co., Ltd (China), Alfa Aesar (USA), Sigma-Aldrich (USA), Shin-Etsu (Japan), Osaka Titanium Corporation (Japan), and Nanostructured and Amorphous Materials Corp. (USA), Group 14 technology (USA).

Graphite is available commercially in natural and synthetic forms, and suitable graphite includes either natural or synthetic graphite or the like. Graphite is a crystalline form of carbon with covalently bonded carbon in sheets. As used herein, graphite refers to graphitic carbon without requiring perfect crystallinity, and some natural graphite materials can have some crystalline impurities. But the graphite refers generally to a material dominated by a graphitic structure, as would be recognized in the art. Graphite is electrically conductive along the plane of the covalent carbon sheets that are stacked in the crystal. The crystalline carbon in graphitic forms can intercalate lithium, so that it is an established electrochemically active material for lithium ion batteries.

Graphite particles can have average particle diameters from about 1 micron to about 30 microns, in further embodiments from about 1.5 microns to about 25 microns, and in other embodiments from about 2 microns to about 20 microns. In general, it is desirable for the graphite to not include particles greater than the electrode thickness to avoid a bumpy electrode surface, and graphitic particles with a size significantly less than a micron can be less crystalline. In some embodiments, the graphitic carbon can have a D50 (mass median diameter) from about 5 microns to about 50 microns, in further embodiments from about 7 microns to about 45 microns and in additional embodiments from about 8 microns to about 40 microns. Also, in some embodiments the BET surface area of graphitic carbon active material (which can be evaluated according to ISO 4652) can be from about 1 m²/g to about 100 m²/g, in further embodiments from about 5 m²/g to about 85 m²/g and in additional embodiments from about 7.5 m²/g to about 60 m²/g. A person of ordinary skill in the art will recognize that additional ranges of particle size and surface area for graphitic carbon active materials are contemplated and are within the present disclosure. In comparison, electrically conductive carbon blacks or the like (which have been referred to as paracrystalline) generally have surface areas of at least roughly 40 m²/g to 1000 m²/g or greater. Graphite can also be characterized by its initial discharge capacity and coulombic efficiencies which can be greater than 300 mAh/g and 90% respectively.

Hard carbon, also known as non-graphitizable carbon, is a form of carbon that is characterized by its amorphous structure and inability to transform into graphite even when subjected to high temperatures. It is produced through the pyrolysis of carbon-rich organic precursors under conditions that prevent the formation of a crystalline graphitic structure. Hard carbon is known for its high stability, large surface area, and irregular, disordered structure. Hard carbons can be manufactured from many carbon rich feedstocks such as: recycled/waste plastics such as phenolic resin, polyurethane, polyethylene, poly propylene, polyvinyl chloride, polystyrene, acrylonitrile-butadiene-styrene copolymer, etc., and low ash biomass waste such as bagasse, cottonseed hulls, various nutshells, etc. Further, coal sources can also be used in the manufacturing, such as Anthracite, Bituminous coal, fat coal, coking coal, asphalt coke, etc. It has been found that using both such waste materials in combination with such coal sources, certain desirous qualities result in the finished hard carbon. In addition to traditional hard carbon manufacturing processes, using a combination of waste materials and coal sources can produce a hard carbon which improves first cycle efficiency at a reduced cost and environmental impact.

Hard carbons can have D50 (mass median diameter) from about 1 micron to about 10 microns, in further embodiments from about 1.5 microns to about 8 microns, and in other embodiments from about 2 microns to about 5 microns. Also, in some embodiments the specific surface area (SSA) of hard carbon active material (which can be evaluated according to ISO 4652, and GB/T19587-2017) can be from about 1 m²/g to about 100 m²/g, in further embodiments from about 2 m²/g to about 20 m²/g and in additional embodiments from about 3 m²/g to about 6 m²/g. A person of ordinary skill in the art will recognize that additional ranges of particle size and surface area for hard carbon active materials are contemplated and are within the present disclosure. Hard carbons can also be characterized by its specific capacity and initial coulombic efficiencies which can be greater than 280 mAh/g and 80% respectively.

Hard carbon exhibits a turbostratic structure and consists of highly disordered carbon layers, which leads to many defects and pores within the material. A reduced diffusion length for lithium ions and a larger electrode-electrolyte interface for the charge transfer reaction allows for faster ion transport and thus higher charging rates. It is believed that hard carbons are not used in lithium ion batteries because of their relatively low coulombic efficiency, a poor cycle stability, and a unclear lithium storage mechanism.

### Anode Binders and Conductive Additives

The negative electrodes can be designed with both a binder to maintain anode coherence and electrically conductive additives to ensure that electrons can traverse the anode to each active anode material particle.

Electrically conductive carbons, such as carbon nanotubes, carbon black, carbon nanofibers, nanoscale carbons or combinations thereof, function as electrically conductive electrode additives. Anodes are preferably designed to have as much active materials as possible while maintaining their physical integrity and electrical conductivity. So electrically conductive materials which can enable high electrode active loading and densities are preferred.

Binders such as polyvinylidene fluoride (PVDF), carboxymethyl cellulose (CMC), styrene-butadiene rubber (SBR), polyacrylic acid (PAA), lithiated PAA(LiPAA), or mixtures thereof can be added to the anode. Such binders provide tensile strength and adhesion such that the electrode remains coherent and laminated to the current collector. Suitable more flexible polymer components can be selected to be inert with respect to the electrochemistry of the cell and to be compatible with processing with the polyimide. PVDF, CMC, and SBR are available commercially from many sources.

Carbon black refers to synthetic carbon materials and can alternatively be referred to as acetylene black, furnace black, thermal black or other names suggesting the synthesis approach. Carbon black generally is referred to as amorphous carbon. Carbon blacks are available commercially that have been synthesized to provide a desirable level of electrical conductivity, such as Super-P® (Imerys), Ketjenblack® (Akzo Nobel), Shawinigan Black® (Chevron-Phillips), and Black Pearls 2000® (Cabot).

Carbon nanotubes are high-aspect-ratio fibers that generally comprise graphene layers in plates, cones or other forms, which carbon nanotubes comprise graphene sheets folded into tubes. Carbon nanotubes are commercially available, for example, Pyrograf® carbon nanotubes (Pyrograf Products, Inc.), OCSiAl, American Elements, Inc. Carbon nanotubes have been found to be a desirable conductive additive that can improve cycling performance for either a positive electrode or a negative electrode. Single wall or multiwall carbon nanotubes are also available from American Elements, Inc. (CA, USA), Cnano Technologies (China), Fuji, Inc. (Japan), Alfa Aesar (MA, USA) or NanoLabs (MA, USA).

### Cathode Materials

The active materials for lithium ion secondary cells herein generally include, for example, a positive electrode (i.e., cathode) active material with a moderately high average voltage against lithium. In general, various cathode materials can be used. For example, commercially available cathode active materials can be used with existing commercial production availability. Such cathode active materials include, for example, lithium cobalt oxide (LiCoO₂), LiNi_{1/3}Mn_{1/3}Co_{1/3}O₂ (L333 or NMC111), LiNi_{0.6}Mn_{0.2}Co_{0.2}O₂(NMC622), LiNi_{0.8}Mn_{0.1}Co_{0.1}O₂ (MMC811), LiNiCoAlO₂ (NCA), other lithium nickel manganese cobalt oxides (NMC), LiMn₂O₄ (lithium manganese oxide spinel), modified versions thereof, or mixtures thereof.

Nickel rich-lithium nickel cobalt manganese oxides (LiNiₓMn_{y}Co_{z}O₂, 0.45≤x, 0.25≤y, z≤0.35) can be of interest due to lower costs and lower flammability risk relative to lithium cobalt oxide as well as the ability to cycle at higher voltages. Results are presented with the nickel rich-lithium nickel manganese cobalt oxide active materials paired with the improved silicon based negative electrodes to form cell with excellent cycling stability. Also, lithium metal oxide materials with a high specific capacity, which have a layered crystal structure and are lithium rich relative to a LiMO₂ (M=non-lithium metal), high capacity manganese rich compositions, blends of the lithium rich and manganese rich NMC and the nickel rich-NMC positive electrode active compositions can be used.

Specifically, desirable cycling results can be obtained from nickel-rich-lithium nickel manganese cobalt oxide, which can be represented by the formula LiNiₓMn_{y}Co_{z}O₂, with x≥0.3 and x+y+z≈1. Commercially available formulations of these compounds include, for example, LiNi_{0.33}Mn_{0.33}Co_{0.33}O₂(BASF and Targray (Canada)), LiNi_{0.5}Mn_{0.3}Co_{0.2}O₂ (BASF), LiNi_{0.6}Mn_{0.2}Co_{0.2}O₂(Targray (Canada), Umicore (Belgium), and L&F Company (Korea)), LiNi_{0.8}Mn_{0.1}Co_{0.1}O₂(Targray, Canada, LG Chemical, Umicore (Belgium) and L&F Company (Korea)), LiNi_{0.9}Mn_{0.05}Co_{0.05}O₂(BASF and Targray (Canada)).

### Electrolyte

While improved electrode design has significantly improved cycling performance, it has been discovered that further cycling stabilization can be achieved due to improved electrolyte formulation. In an aspect the improved electrolytes are based on solvents such as fluoroethylene carbonate, dimethyl carbonate, ethylene carbonate, methyl acetate, and mixtures thereof. The electrolytes further comprise from about 1M to about 2M of or more electrolyte salts, such as lithium hexafluorophosphate (LiPF₆), lithium bis(fluorosulfonyl) imide (LiFSI) and lithium trifluorosulfonyl imide (LiTFSI).

Fluorinated solvents have been found to be useful in particular for silicon based active materials. The use of fluoroethylene carbonate is understood as a suitable solvent for low temperature cell performance, and useful for the formation of solid electrolyte interphase layers. Electrolytes for lithium ion batteries can comprise one or more selected lithium salts, a non-aqueous solvent and optional additives. It is desired to avoid solvents and other ingredients that have been found to degrade cycling performance. Suitable electrolyte additives include vinylene carbonate (VC), fluoroethylene carbonate (FEC), lithium bisoxalatodifluorophosphate (LiODFP), lithium difluoro(oxalate) borate (LiODFB), difluorophosphinic acid lithium salt (LiPO₂F₂), 1,3,2-Dioxathiolane 2,2-dioxide (DTD), tris(trimethylsilyl) phosphate (TMSP). All these additives are commercially available from Sigma-aldrich (US), Tinci Materials (China), Koura (US), E-Lyt (German).

Appropriate lithium salts generally have inert anions. Suitable lithium salts include, for example, lithium hexafluoroarsenate, lithium bis(trifluoromethyl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Lithium hexafluoro phosphate and lithium tetrafluoroborate are of particular interest. In some embodiments, the electrolyte comprises from about 1 M to about 2 M concentration of the lithium salts, in further embodiments from about 1.1 M to about 1.9 M, and in other embodiments from about 1.25 M to about 1.8 M lithium salt. A person of ordinary skill in the art will recognize that additional ranges of electrolyte salt concentrations within the explicit ranges above are contemplated and are within the present disclosure.

For lithium ion batteries of interest, a non-aqueous liquid is generally used to dissolve the lithium salt(s) in a non-aqueous solvent. The solvent generally does not dissolve the electroactive materials. The solvent selection is significant for the electrolytes described herein that provide for the surprisingly improved cycling performance. Generally, the solvent comprises from about 1 weight percent to about 30 weight percent fluoroethylene carbonate (FEC), in further embodiments from about 7 wt % to about 27 wt % and in additional embodiments from about 8 wt % to about 25 wt % FEC. Correspondingly, the solvent is generally substantially free of ethylene carbonate since ethylene carbonate has been found to be detrimental for cycling.

The electrolyte solvents generally also comprise room temperature liquid components, and the solvents of particular interest further comprise linear carbonate esters and optional additives. Desirable linear carbonate esters include, for example, dimethyl carbonate, ethylmethyl carbonate and diethyl carbonate. In some embodiments, the total volume contributed to the solvent by the dimethyl carbonate, ethylmethyl carbonate, and diethyl carbonate can be from about 50 volume percent to about 95 volume percent, in further embodiments from about 55 volume percent to about 92.5 volume percent and in additional embodiments from about 60 volume percent to about 91 volume percent combined contributions from dimethyl carbonate, ethylmethyl carbonate and diethyl carbonate. In some embodiment, the solvent consists essentially of fluoroethylene carbonate and one or more of dimethyl carbonate, ethylmethyl carbonate and diethyl carbonate. A person of ordinary skill in the art will recognize that additional ranges of solvent components within the explicit ranges above are contemplated and are within the present disclosure.

In some embodiments, the solvent can further comprise propylene carbonate (PC) and/or fluorobenzene (FB). If either or both of these optional solvent components are present, the solvent can generally comprise independently from about 0.5 volume percent to about 12 volume percent, in further embodiments from about 0.75 to about 10 volume percent, and other embodiments form about 1 to about 8 volume percent of one or both of these solvent components. While the PC or FB solvent components do not significantly alter the cycling performance, these solvent components can be desirable for processing advantages, such as reducing gas formation. A person of ordinary skill in the art will recognize that additional ranges of PC and/or FB solvent concentrations within the explicit ranges above are contemplated and are within the present disclosure.

Generally, the solvent may comprise other minor components generally at no more than about 20 volume percent total of these other solvent components, in some embodiments no more than about 10 volume percent, in other embodiments from about 0.01 volume percent to about 5 volume percent, and in further embodiments from about 0.1 volume percent to about 1 volume percent. A person of ordinary skill in the art will recognize that additional ranges of solvent components within the explicit ranges above are contemplated and are within the present disclosure. In some embodiments, other appropriate solvent ingredients that may optionally be present in minor amounts include, for example, 2-methyl tetrahydrofuran, dioxolane, tetrahydrofuran, γ-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof. Other minor fluorinated solvent components can include, for example, fluorinated vinyl carbonate, monochloro ethylene carbonate, monobromo ethylene carbonate, 4-(2,2,3,3-tetrafluoropropoxymethyl)-[1,3]dioxolan-2-one, 4-(2,3,3,3-tetrafluoro-2-trifluoro methyl-propyl)-[1,3]dioxolan-2-one, 4-trifluoromethyl-1,3-dioxolan-2-one, bis(2,2,3,3-tetrafluoro-propyl) carbonate, bis(2,2,3,3,3-pentafluoro-propyl) carbonate, or mixtures thereof. Additional fluorinated minor solvent components include, for example, fluorinated ethers.

In an aspect the electrolyte can comprise the composition detailed in U.S. patent Ser. No. 11/177,505 or contain aspects thereof, and the '505 patent is hereby incorporated herein by reference. The composition comprises: (i) at least one aprotic organic solvent; (ii) at least one conducting salt; (iii) at least one pyridine-SO₃ complex of formula (I)

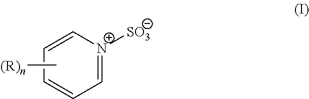

Wherein R is selected independently at each occurrence from F, C₁ to C₁₀ alkyl, C₂ to C₁₀ alkenyl, and C₂ to C₁₀ alkynyl, wherein alkyl, alkenyl, and alkynyl may be substituted by one or more substituents selected from F and CN; and n is an integer selected from 1, 2, 3, 4, and 5; and optionally one or more additives.

In an aspect the electrolyte can comprise the composition detailed in U.S. patent Ser. No. 10/720,668 or contain aspects thereof, and the '668 patent is hereby incorporated herein by reference. The composition comprises at least one aprotic organic solvent and at least one compound of formula (II):

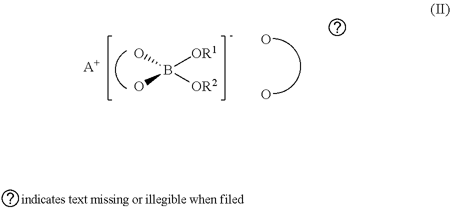

wherein: A⁺ is selected from the group consisting of Li⁺, Na⁺, K⁺, Cs⁺, and ammonium;

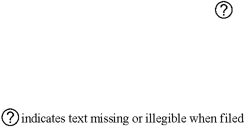

is a bidentate radical derived from a (hetero)aromatic 1,2-, 1,3- or 1,4-diol, from a (hetero)aromatic 1,2-, 1,3- or 1,4-dicarboxylic acid or from a (hetero)aromatic 1,2-, 1,3- or 1,4-hydroxycarboxylic acid by abstracting the two H atoms of pairs of adjacent OH groups; and R¹ and R² are independently selected from the group consisting of C₁ to C₁₀ alkyl, C₂ to C₁₀ alkenyl, C₂ to C₁₀ alkynyl, C₃ to C₁₀ cycloalkyl, and C₅ to C₁₄ (hetero)aryl, wherein alkyl, alkenyl, alkynyl, cycloalkyl, and (hetero)aryl may be substituted by one or more substituents selected from F, CN, and optionally fluorinated groups selected from C₁ to C₄ alkyl, C₂ to C₄ alkenyl, C₂ to C₄ alkynyl, phenyl, and benzyl. This composition can include optionally one or more additives.

### Cell Design

In general, the electrode designs described herein can be adapted for cylindrical cells or more rectangular or prismatic style batteries. Cylindrical batteries generally have wound electrode structures while prismatic shaped batteries can have either wound or stacked electrodes. In general, to achieve desired performance capacities with appropriate electrode design with respect to electrode loadings and densities, the cell can comprise a plurality of electrodes of each polarity that can be stacked with separator material between electrodes of a cell. Winding of the electrodes in a jellyroll construction can provide a similar effect with a reasonable internal resistance due to electron conductivities and ion mobilities as well as good packing of the electrodes within an appropriate container.

A pouch battery comprises a pouch enclosure enveloping a prismatic battery. The pouch enclosure is sealed around the battery, but generally has at least two tabs extending outward from the sealed pouch enclosure for electrical contact with the enclosed battery. Many embodiments of pouch batteries are possible with different configurations of the edges and seals, number of electrodes comprising the battery, and the arrangement of such electrodes. In an aspect the electrodes are enveloped by an enclosure other than a pouch such as a prismatic housing or wound into a cylinder and housed in a metal cylinder to form a cylindrical cell.

Generally, a battery with stacked electrodes of the dimensions described herein have from 5 to 40 negative or positive electrode elements (current collector coated on both sides with active material) and in other aspects from 5 to 40 positive electrode elements with corresponding numbers of negative electrode elements being generally one less or more than the negative electrode elements. A person of ordinary skill in the art will recognize that additional ranges of electrode numbers within the explicit ranges above are contemplated and are within the present disclosure.

### General Battery Features

The negative electrode and positive electrode structures can be assembled into appropriate cells. As described further below, the electrodes are generally formed in association with current collectors to form electrode structures. A separator is located between a positive electrode and a negative electrode to form a cell. The separator is electrically insulating while providing for at least selected ion conduction between the two electrodes. A variety of materials can be used as separators. Some commercial separator materials can be formed from polymers, such as polyethylene and/or polypropylene that are porous sheets that provide for ionic conduction. Commercial polymer separators include, for example, the Celgard® line of separator material from Asahi Kasei (Japan) Also, ceramic-polymer composite materials have been developed for separator applications. These ceramic composite separators can be stable at higher temperatures, and the composite materials can reduce the fire risk. Polymer-ceramic composites for lithium ion battery separators are sold under the trademark Separion® by Evonik Industries, Germany and Lielsort® by Tiejin Lielsort Korea Co., Ltd.

### Electrode Structures

The electrodes of the cell comprise the active material along with binders and conductive additives. The electrodes are formed into a sheet, dried and pressed to achieve a desired density and porosity. The electrode sheets are generally formed directly on a metal current collector, such as a metal foil or a thin metal grid. For many cell structures, electrode layers are formed on both sides of the current collector to provide for desirable performance in the assembled cell or battery. The electrode layers on each side of the current collector can be considered elements of the same electrode structure since they are at the same potential in the cell.

In some embodiments, when the positive electrode or negative electrode uses a high loading level, the density of the electrode can be reduced to provide good cycling stability of the electrode. Generally, the density of the electrodes cannot be arbitrarily increased without sacrificing performance with respect to loading levels while achieving desired cycling performance and capacity at higher discharge rates.

In some embodiments, a current collector can be formed from nickel, aluminum, stainless steel, copper or the like. Electrode material can be cast as a thin film onto a current collector. The electrode material with the current collector can then be dried, for example in an oven, to remove solvent from the electrode. In some embodiments, a dried electrode material in contact with a current collector foil or other structure can be subjected to a pressure from about 2 to about 10 kg/cm² (kilograms per square centimeter). The current collector used in the positive electrode can have a thickness from about 5 microns to about 30 microns, in other embodiments from about 10 microns to about 25 microns, and in further embodiments from about 14 microns to about 20 microns. In one embodiment, the positive electrode uses an aluminum foil current collector. The current collector used in the negative electrode can have a thickness from about 2 microns to about 20 microns, in other embodiments from about 4 microns to about 14 microns, and in further embodiments from about 6 microns to about 10 microns. In one embodiment, the negative electrode uses copper foil as current collector. A person of ordinary skill in the art will recognize that additional ranges of current collector thicknesses within the explicit ranges above are contemplated and are within the present disclosure.

### Negative Electrodes

The basic electrode design comprises a blend of active compositions, polymer binders, and electrically conductive additives. The active material blend can comprise in some embodiments a silicon based active material, such as a silicon oxide composite, at least 35 weight percent of distinct graphite, and an optimized amount of hard carbon—about 5-10% in an aspect, but can range from 5-30 wt % in another aspect.

As described herein, improved cycling results are obtained with a blended active composition with a silicon based active material and graphitic carbon. Generally, an overall capacity of the negative electrode blended active material can be at least about 440 mAh/g, in alternative embodiments at least about 750 mAh/g, in further embodiments at least about 900 mAh/g, in additional embodiments at least about 1000 mAh/g, when cycled against lithium metal from 10 millivolts (mV) to 1.5V at a rate of C/3. The blended active material can comprise at least about 10 wt % silicon based active material, in further embodiments at least about 30 wt % silicon based active material, in other embodiments from about 5 wt % to about 40 wt % silicon based active material. The composite active anode material can comprise from about 5 wt % graphite to about 70 wt % graphite, in further embodiments from about 45 wt % graphite to about 65 wt % graphite. The composite active anode material can comprise from about 1 wt % hard carbon to about 30 wt % hard carbon, in further embodiments from about 4 wt % hard carbon to about 15 wt % hard carbon and in other aspects from about 5 wt % hard carbon to about 10 wt % hard carbon. A person of ordinary skill in the art will recognize that additional ranges of specific discharge capacity and concentrations of silicon based active material within the explicit ranges above are contemplated and are within the present disclosure.

The negative electrode used in the cells described herein can have high active material loading levels along with reasonably high electrode density. For a particular active material loading level, the density is inversely correlated with thickness so that an electrode with a greater density is thinner than an electrode with a lower density. Loading is equal to the density times the thickness. In some embodiments, the negative electrode of the battery has a loading level of negative electrode active material that is at least about 1.5 mg/cm², in other embodiments from about 2 mg/cm² to about 8 mg/cm², in additional embodiments from about 2.5 mg/cm² to about 6 mg/cm², and in other embodiments from about 3 mg/cm² to about 4.5 mg/cm². In some embodiments, the negative electrode of the battery has an active material density in some embodiments from about 0.5 g/cc (cc=cubic centimeters (cm³)) to about 2 g/cc, in other embodiments from about 0.6 g/cc to about 1.5 g/cc, and in additional embodiments from about 0.7 g/cc to about 1.3 g/cc. Similarly, the composite silicon based electrodes can have an average dried thickness of at least about 15 microns, in further embodiments at least about 20 microns and in additional embodiments from about 25 microns to about 75 microns. The resulting silicon based electrodes can exhibit capacities per unit area of at least about 3.5 mAh/cm², in further embodiments at least about 4.5 mAh/cm² and in additional embodiments at least about 6 mAh/cm². A person of ordinary skill in the art will recognize that additional ranges of active material loading level and electrode densities within the explicit ranges above are contemplated and are within the present disclosure.

### Forming Electrodes

To form the electrode, the powders can be blended with the polymer in a suitable liquid, such as a solvent for dissolving the polymer. PVDF can generally be processed in N-methyl pyrrolidone (NMP), although other suitable organic solvents may be used. Water processable binders can be also used, and these water processable binders are suitable for blending with a wider range of other polymers. The particulate components of the electrode, i.e., the active material and conductive carbon, can be blended with the polymer binder blend in the solvent to form a paste. The resulting paste can be pressed into the electrode structure.

The active material loading in the binder can be large. In some embodiments, the negative electrode has from about 75 to about 98 wt % of negative electrode active material, in other embodiments from about 85 to about 96 wt % of the negative electrode active material, and in further embodiments from about 90 to about 96 wt % of the negative electrode active material. In some embodiments, the negative electrode has from about 1 to about 8 wt % polymeric binder, in other embodiments about 1 to 6 wt % polymeric binder, and in further embodiments from about 1 to 5 wt % polymeric binder. A person of ordinary skill in the art will recognize that additional ranges of polymer loadings within the explicit ranges above are contemplated and are within the present disclosure.

For improved cycling negative electrodes, carbon additives or combinations thereof have been found to be particularly desirable. Conductive carbon refers generally to particles of high surface area elemental carbon. Suitable conductive carbon includes, for example, carbon black, carbon nanotubes and other electrically conductive carbons. In some embodiments, the negative electrode comprises from about 1 to about 7 wt % nanoscale conductive carbon, in further embodiments form about 1 to about 6.5 wt %, and in additional embodiments from about 0.05 to about 2 wt % nanoscale conductive carbon. A person of ordinary skill in the art will recognize that additional ranges of particles loadings and conductivities within the explicit ranges about are contemplated and are within the present disclosure.

### High Power Silicon Based Anode Materials

In general, the battery designs herein are based on a high-power anode active material. Specifically, the anode active materials generally have a specific capacity of at least about 800 mAh/g, in further embodiments at least about 900 mAh/g, in additional embodiments at least about 1000 mAh/g, in some embodiments at least about 1150 mAh/g and in other embodiments at least about 1400 mAh/g when cycled at a rate of C/10 against lithium metal from 0.005V to 1.5V. As this implies, the specific capacity of negative electrode active material can be evaluated in a cell with a lithium metal counter electrode. However, in the batteries described herein, the negative electrodes can exhibit reasonably comparable specific capacities when cycled against high-capacity lithium metal oxide positive electrode active materials. In the battery with non-lithium metal electrodes, the specific capacity of the respective electrodes can be evaluated by dividing the battery capacity by the respective weights of the active materials taking account of the excess anode materials by design. As described herein, desirable cycling results can be obtained with a combination of a silicon based active material and a graphitic carbon active material with good capacities observed.

Also, carbon coatings can be applied over the silicon-based materials to improve electrical conductivity, and the carbon coatings seem to also stabilize the silicon-based material with respect to improving cycling and decreasing irreversible capacity loss. Desirable carbon coatings can be formed by pyrolizing organic compositions. The organic compositions can be pyrolyzed at relatively high temperatures, e.g., about 800° C. to about 900° C., to form a hard amorphous coating. In some embodiments, the desired organic compositions can be dissolved in a suitable solvent, such as water and/or volatile organic solvents for combining with the silicon-based component. The dispersion can be well mixed with silicon-based composition. After drying the mixture to remove the solvent, the dried mixture with the silicon-based material coated with the carbon precursor can be heated in an oxygen free atmosphere to pyrolyze the organic composition, such as organic polymers, some lower molecular solid organic compositions and the like, and to form a carbon coating on the silicon oxide, silicon or other anode material. Commercial SiO—Si—C composite compositions are presently commercially available such as from Shin-Etsu Chemical Company, Japan, KSC-series products.

In an aspect, Silicon carbide (SiC) is added as an additional anode active material and/or used as a protective layer for silicon, silicon oxide or other active materials. Silicon carbides (SiCx) differ from Si/carbon (Si/C) composites. The Si/C composites are produced by dispersing silicon within a carbon matrix whereas SiC is a covalent compound. Some forms of SiCx, e.g. where x=1, are inert for lithium insertion. However, preparing SiC with Si can improve the electrochemical activity, presumably by acting as a buffer matrix to face the volume expansion. So that Si/SiC can have both electrochemically active silicon and buffer matrix to face the volume expansion. Although, SiC is inert for lithium ion insertion, SiC₂, SiC₃, SiC₅ and SiC₇ molecule configurations have shown their acceptance for lithium. They can be mixed with other active materials to add to the anodes high theoretical capacity, low electrochemical potential, and good rechargeability.

### Positive Electrodes

Various positive electrode chemistries can be introduced effectively with the improved negative electrodes described above. The selected compositions can be blended into positive electrode along with a suitable binder and electrically conductive materials. This section focuses on particularly desirable positive electrode active materials for high power performance. Also, this section describes the overall electrode composition and properties.

To some degree, the desired application of the final cells can influence the selection of the positive electrode composition. From this perspective, a broad range of compositions are described in the following. For high power use, nickel-rich lithium nickel manganese cobalt oxides are found to provide the desired high voltage and long cycling performance. In other aspects, many other known and commercially available positive active materials provide reasonable positive electrode performance. The nickel rich lithium nickel manganese cobalt oxides alone as the active material can provide desirably high energy densities due to the average discharge voltage with good cycling when paired with the silicon based negative electrodes described herein. Examples are presented below for a nickel rich lithium nickel manganese cobalt oxides alone.

The nickel-rich compositions can be approximately represented by the formula LiNiₓMn_{y}Co_{z}O₂, x+y+z≈1, 0.45≤x, 0.025≤y, ≤0.35, in further embodiments, 0.50≤x, 0.03≤y, z≤0.325, and in 0.55≤x, 0.04≤y, z≤0.3. The amount of nickel can influence the selected charge voltage to balance cycling stability and discharge energy density. For values of x in the range of 0.525≤x≤0.7 a selected charge voltage can be from 4.25V to 4.375V. For values of x in the range of 0.7≤x≤0.9, the selected charge voltage can be from 4.05V to 4.325V. A person of ordinary skill in the art will recognize that additional ranges of composition and selected charge voltages within the explicit ranges above are contemplated and are within the present disclosure. These compositions have been found to provide relatively stable higher voltage cycling, good capacities and desirable impedance and the average voltage trends slightly larger with increasing amounts of nickel. NMC powders can be synthesized using techniques, such as coprecipitation described further below, and these are available commercially, such as from BASF (Germany), TODA (Japan), L&F Materials Corp. (Korea), Umicore (Belgium), and Jinhe Materials Corp. (China).

For the active material blends for a positive electrode, the positive electrode active material blends, the active materials can comprise from about 15 weight percent to about 98 weight percent NMC, in further embodiments, from about 25 weight percent to about 98 weight percent, in additional embodiments from about 30 weight percent to about 98 weight percent, and in other embodiments from about 35 weight percent to about 98 weight percent NMC. The positive electrode active materials can optionally comprise from 0 to 50 weight percent additional active materials, such as an additional NMC or LiNi_{0.8}Co_{0.15}Al_{0.05}O₂ (NCA), LFP, LMFP, LMNO, mixtures thereof, or the like. A person of ordinary skill in the art will recognize that additional ranges of composition blends within the explicit ranges above are contemplated and are within the present disclosure.

As noted above, the positive electrode generally comprises active material, with an electrically conductive material within a binder. The active material loading in the electrode can be large. In some embodiments, the positive electrode comprises from about 85 to about 99% of positive electrode active material, in other embodiments from about 90 to about 98% of the positive electrode active material, and in further embodiments from about 95 to about 97.5% of the positive electrode active material. In some embodiments, the positive electrode has from about 0.75 to about 10% polymeric binder, in other embodiments from about 0.8 to about 7.5% polymeric binder, and in further embodiments from about 0.9 to about 5% polymeric binder. The positive electrode composition generally can also comprise an electrically conductive additive distinct from the electroactive composition. In some embodiments, the positive electrode can have 0.4 weight percent to about 12 weight percent conductive additive, in further embodiments from about 0.45 weight percent to about 7 weight percent, and in other embodiments from about 0.5 weight percent to about 5 weight percent conductive additive. A person of ordinary skill in the art will recognize that additional ranges of particles loadings within the explicit ranges about are contemplated and are within the present disclosure. The positive electrode active materials are described above. Suitable polymer binders for the positive electrode include, for example, PVDF, polyethylene oxide, polyimide, polyethylene, polypropylene, polytetrafluoroethylene, polyacrylates, rubbers, e.g. ethylene-propylene-diene monomer (EPDM) rubber or styrene butadiene rubber (SBR), copolymers thereof, or mixtures thereof. For the positive electrode, PVDF can be used with good results, and the positive electrodes in the examples use a PVDF binder. Electrically conductive additives are described in detail for the negative electrode, and nanoscale conductive carbon can be used effectively for the positive electrode.

For a particular loading level, the electrode density (of active material) is inversely correlated with thickness so that an electrode with a greater density is thinner than an electrode with a lower density. Loading is equal to the density times the thickness. In some embodiments, the positive electrode of the battery has a loading level of positive electrode active material that is from about 10 to about 40 mg/cm², in other embodiments from about 12 to about 37.5 mg/cm², in additional embodiments from about 13 to about 35 mg/cm², and in other embodiments from 20 to about 32.5 mg/cm². In some embodiments, the positive electrode of the battery has an active material density in some embodiment from about 2.5 g/cc to about 4.6 g/cc, in other embodiment from about 3.0 g/cc to 4.4 g/cc, and in additional embodiment from about 3.25 g/cc to about 4.3 g/cc. In further embodiments, the positive electrodes can have a thickness on each side of the current collector following compression and drying of the positive electrode material from about 45 microns to about 300 microns, in some embodiments from about 80 microns to about 275 microns and in additional embodiments from about 90 microns to about 250 microns. A person of ordinary skill in the art will recognize that additional ranges of active material loading level, electrode thickness and electrode densities within the explicit ranges above are contemplated and are within the present disclosure.

### Performance Properties

The improved negative electrode designs comprising the composite silicon oxide, graphite and hard carbon can provide longer cycling stability while maintaining desirable battery performance. The achievement of the long-term cycling involves use of the improved electrode designs described herein with the balance of cell design parameters in combination with the electrolyte and positive electrode formulation that surprisingly further extend the cycling with unprecedented stability.

The selected charge voltage can be influenced by the positive electrode active material. Generally, the selected charge voltage for these cells is from about 4.05V to 4.4V. The batteries can exhibit very good cycling performance. In some embodiments, the batteries can exhibit a discharge capacity at cycle 700 of at least about 80% of the first cycle capacity discharged at 1 C rate from the selected charge voltage to 4.2V at 30° C. In other embodiments at least about 82% and in additional embodiments at least about 84% at the 700th cycle relative to first cycle discharge capacity when cycled from the selected charge voltage to 4.2V at 1 C at 30° C. Similarly, the batteries can exhibit a discharge capacity at cycle 725 of at least about 80% of the first cycle capacity discharged at 1 C rate from the selected charge voltage to 4.2V at 30° C., in other embodiments at cycle 750 of at least about 80% and in additional embodiments at cycle 800 of at least about 80% relative to the first cycle discharge capacity when cycled from the selected charge voltage to 4.2V at 1 C at 30° C. Comparable results are obtained at 2 C charge and discharge rates. A person of ordinary skill in the art will recognize that additional ranges within the explicit ranges above are contemplated and are within the present disclosure.

### EXAMPLES

The compositions and processes described here, and ways to make and use them are illustrated in the following examples.

### Example 1

Experimental amounts of hard carbon were sourced from Chendu Baisige Technology company of Sichuan China (aka Best Graphite), and analyzed as follows:

The hard carbon material resembles a core-shell hard carbon structure which has the physical properties detailed in Table 1. Electrochemical measurements were also performed and are detailed in Table 1.

TABLE 1

| Property | Measurement | Test method |
|---|---|---|
| Particle Size D₅₀ | 2.5-4.5 microns | GB/T19077-2016 |
| Tap density g/cm³ | Greater than or equal to 5.0 microns | GB/T 5162-2021 |
| Specific surface area m²/g | Less than or equal to 5.0 microns | GB/T19587-2017 |
| Specific Capacity mAh/g | Greater than or equal to 280 | Standard testing |
| Initial Coulomb Efficiency % | Greater than or equal to 80 | Standard testing |

### Example 2

### Specific Half Cell Formulation

In general, cell formulations were tested through their incorporation into coin cells using Li chips as the countering electrode and working electrodes incorporating a composite of silicon oxide, hard carbon and graphite as the active materials. The negative electrode active material was a commercial SiO (SiOₓ) that was blended with both electrochemically active graphite and electrochemically active hard carbon. However, in this example, an anode half cell is tested for its performance after its manufacture. Half cells of varying composition are compared to understand how the addition of hard carbon can affect performance.

To start the manufacture of the negative electrode with the composite active material, desired ingredients were added stepwise, unless otherwise noted. In a first step, polyacrylic acid, carbon black and carbon nanotubes were blended at a desired anode additive composition. To this anode additive composition, active anode ingredients were then added a portion at a time along with water to ensure the mixture does not get too dry. In an aspect, a portion of the desired graphite is first added and mixed into the anode additive composition. After the first portion of graphite powder is thoroughly mixed additional portions are similarly added until all of the graphite is mixed in. In this aspect, portions of the hard carbon are then added a portion at a time until mixed thoroughly and then the SiO powder is added portion-wise. Finally, a desired amount of styrene butadiene rubber is added to the anode mixture which is in the form of a wet emulsion in water.

To form the anode, the composite slurry is then cast onto a 10 micron thick copper foil, which is then dried for about 10-30 minutes at an elevated temperature (50° C.-80° C.). This cast anode is then calendered to achieve a target density of about 1.6 g/cc. The calendered anode is then further dried using a vacuum drying until the dried anode has a density of about 1.6 g/cc and an areal capacity of about 1.5-1.8 mAh/cm². These densities will vary depending on the active materials mixture.

Several half cells were constructed according to the examples detailed process and their composition is described in Table 2.

TABLE 2

| Anode | | | |
|---|---|---|---|
| compostion # | Graphite | SiOx | HC |
| 1 | 65.97 | 28.27 | 0 |
| 2 | 61.26 | 28.27 | 4.71 |
| 3 | 56.54 | 28.27 | 9.42 |
| 4 | 47.12 | 28.27 | 18.85 |
| 5 | 37.7 | 28.27 | 28.27 |

The concentrations in Table 2 are relative total actives weight excluding binder and conductive additives. In all cells, the total actives are 94.3% of the anode composition dry weight. As the silicon oxide concentration remains constant, the rising hard carbon concentration takes the place of graphite, and includes cells 2-5 with HC concentrations of 5, 10, 20 and 30 wt % of actives.

### Example 3

### Half Cell Testing and Optimization of HC %

Each half cell was subjected to several tests to determine if there was variation in performance.

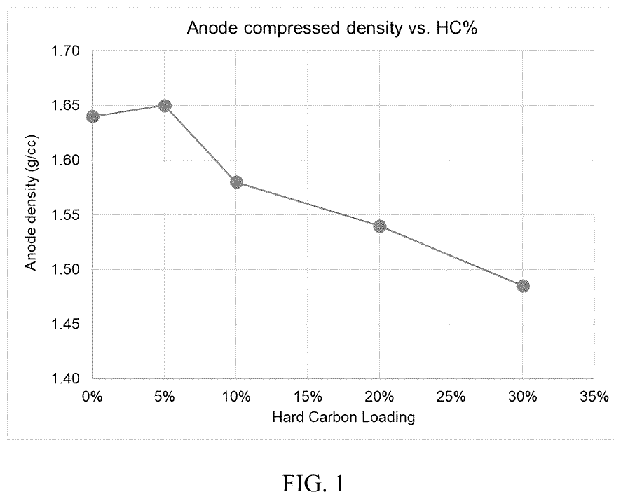

In a first test, the density of each anode composition was measured, and the results are shown in FIG. 1.

At 5% HC loading, Composition 2 demonstrated the least compromise in electrode density relative to zero HC loading. This should translate to almost no loss of volumetric density at cell level.

Referring to Table 3, selected half cells were tested for specific capacity verses HC %. Three step charge (Li insertion to Si anode) at C/10, C/20, C/50 to 5 mV were consecutively performed. Then first discharge capacity at 0.1 C, to 1.5V was calculated. 0.33 C charge capacity was determined after 0.33 C charge to 5 mV. Similarly, 1 C and 3 C charge capacity was determined after 1 C and 3 C charge to 5 mV. 1 C and 3 C. 1 C current (in mA) was calculated based on the nominal capacity assuming theoretical specific capacity at 650 mAh/g accounting all SiOₓ, HC and Graphite active materials. The performance of the 5 and 10 wt % HC samples performed slightly more poorly than the 0% HC because of the HC at low drain rates.

TABLE 3

| | 0% HC | 5% HC | 10% HC |
|---|---|---|---|
| FCE (%) | 90.13 | 90.14 | 89.95 |
| 0.1 C Discharge (mAh/g) | 729.99 | 723.10 | 713.73 |
| 0.1 C Charge (mAh/g) | 657.64 | 651.83 | 641.98 |
| 0.33 C Charge (mAh/g) | 652.44 | 642.74 | 627.65 |
| 1 C Charge (mAh/g) | 640.09 | 631.75 | 615.10 |
| 3 C Charge (mAh/g) | 628.24 | 615.38 | 600.50 |

### Example 4

Full coin cells were constructed using the anode formulations detailed in the above examples, and using NCM as the active cathode material. Examples of positive electrodes active materials were NMCs having the formula LiNi_{0.9}Mn_{0.05}Co_{0.05}O₂ (NMC9055) and LiNi_{0.8}Mn_{0.1}Co_{0.1}O₂(NMC811).

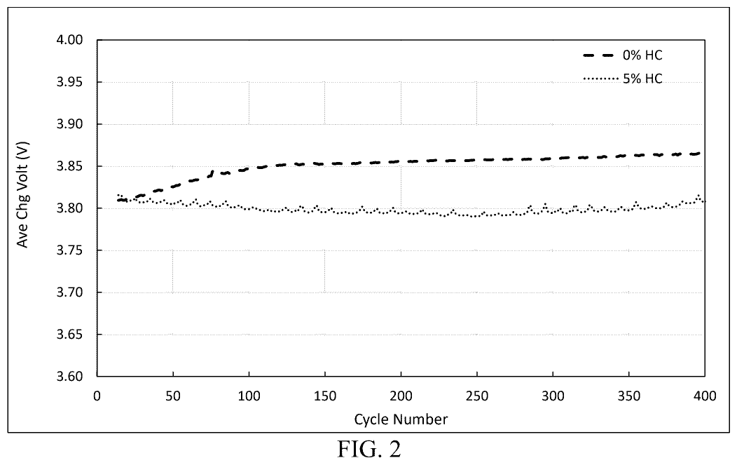

Referring to FIGS. 2-4, additional full cell testing of the anode compositions was conducted. Cycling data of coin cells were recorded on Neware BTS4000 testers.

FIG. 2 details the average charging voltage or charge energy/charge capacity for each cycle for the voltage range of 4.2V-2.5V with the cycling rate of 1 C symmetric, on both charge and discharge. Results for both 5 wt % HC and 0% HC are displayed with the average charge voltage for the 5 wt % HC being consistently lower than the control (0 wt % HC).

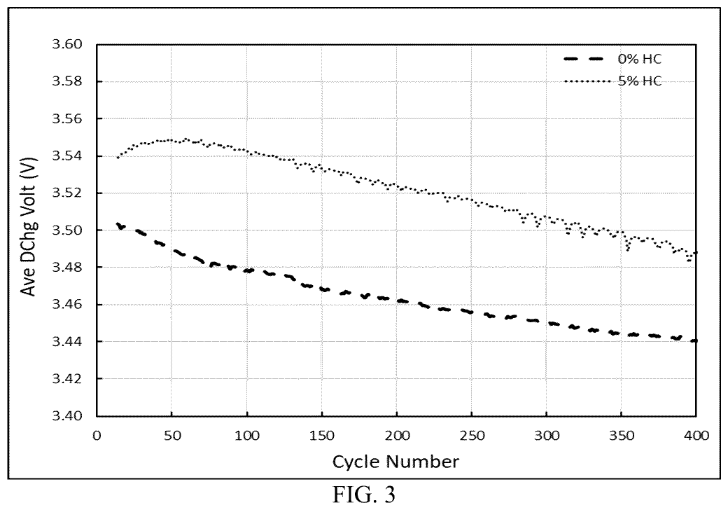

FIG. 3 details the average discharge voltage or discharge energy/discharge capacity for each cycle for the voltage range of 4.2V-2.5V with the cycling rate of 1 C symmetric, on both charge and discharge. Results for both 5 wt % HC and 0% HC are displayed with the average discharge voltage for the 5 wt % HC being consistently higher than the control (0 wt % HC).

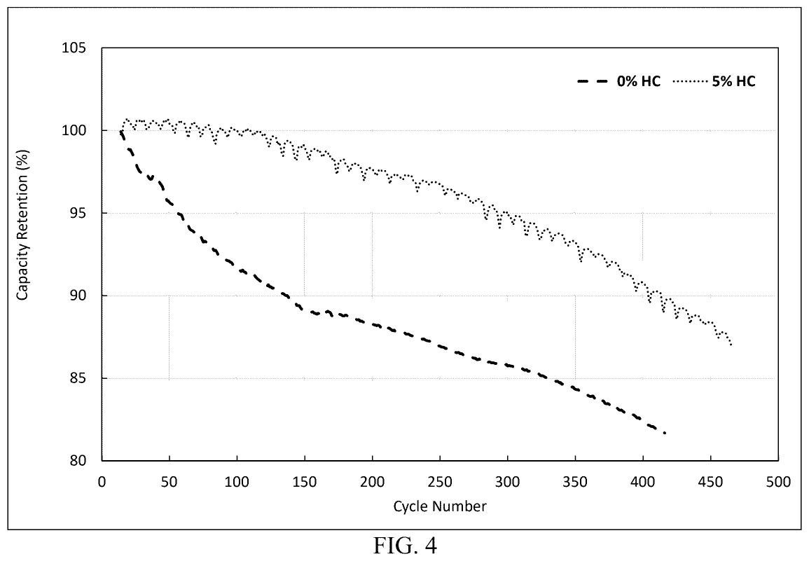

FIG. 4 details capacity retention during cycling performance of full cells containing the same anode concentrations of both 5 wt % HC and 0% HC half cells. Capacity retention was normalized to the first 1 C capacities (formation cycles not shown). After cycling, the 5 wt % cell designs retains significant capacity relative to the control cells.

In each of these half cell tests the 5 wt % cells perform better than the control appears to show an optimized wt % of HC.

High rate testing was conducted on these cells to investigate whether higher (10 wt %) HC anode loading would perform relative to control cells. This is a new set of examples, where cells were formed and go through a series of symmetric high rate tests, up to 20 C.

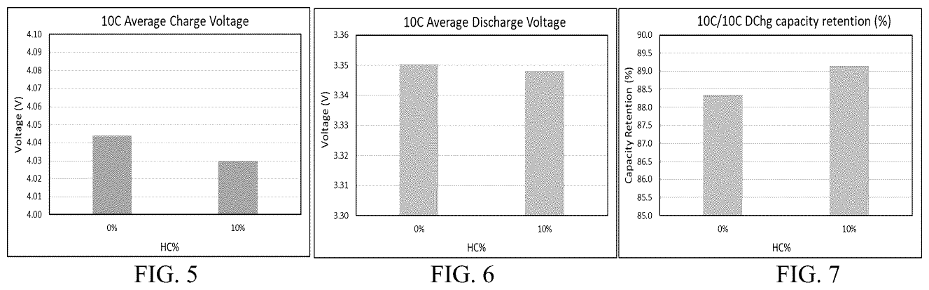

The cell was first run through formation cycles at C/10 for 2 cycles. They were then through a series of C-rate tests for a voltage range of 4.2V-2.5V: 2 cycles each at C/5, C/3, 1C, 2 C, 3 C, 5 C, 10 C, 15C, 20 C. Referring to FIGS. 5-7, 10 C data comparison of 0% and 10 wt % HC is shown.

FIG. 5 shows average charge voltages for the 10 wt % HC and control cells. The charge voltage is lower for the 10 wt % cells showing lower impedance and less power needed for charge.

FIG. 6 shows average discharge voltages for the 10 wt % HC and control cells. The discharge voltage is about the same for the 10 wt % cells relative the control showing that higher HC loading does not decrease discharge voltage at high discharge rates.

FIG. 7 shows average capacity retention for the 10 wt % HC and control cells. The capacity retention is higher for the 10 wt % cells showing the beneficial effect of the higher HC anode loading.

### Example 5

### Pouch Cell Manufacture

In general, the full cell formulations are the same as their coin cells counterparts described in earlier examples. The full cell formulations also include NMC positive electrodes and negative electrodes incorporating a composite of silicon oxide, hard carbon and graphite as the active materials.

To start the manufacture of the negative electrode with the composite active material, desired ingredients were added stepwise into a planetary mixer. All active anode ingredients, along with carbon black were blended dry, and to the dry mixture, polyacrylic acid and deionized water, carbon nanotubes and styrene butadiene rubber are added and mixed to form the anode mixture slurry.

To form the anode, the composite slurry is then cast onto copper foil, double-sided, which is then dried for about 10-30 minutes at an elevated temperature (50-80° C.). The calendered anode is then further vacuum dried at 80° C. for more than 12 hours. This cast anode is then calendered to achieve a target density of about 1.6 g/cc, Final with an areal capacity of about 3.5-4.0 mAh/cm². These densities will vary depending on the active materials mixture. Several anodes were constructed according to these examples detailed process and their composition cell 3 as described in Table 2. The negative electrodes were designed with sufficient lithium to create excess anode areal capacity of about 110% to 115%, relative the cathode areal capacity.

For the manufacture of the positive electrode with a lithium metal oxide active material, desired ingredients were added stepwise, unless otherwise noted. In a first step, Polyvinylidene fluoride (PVDF), carbon black and carbon nanotubes were blended at a desired composition. To this cathode additive composition, the active powder was then added a portion at a time along with N-Methyl-2-pyrrolidone (NMP). The final cathode mixture is in the form of a wet and formable slurry. All cathodes are manufactured in a dry room with a dew point of −40° C.

The composite cathode slurry is then cast onto both sides of a current collector, which is then dried for minutes at an elevated temperature (100-120° C.). The calendered cathode is then further dried using a vacuum drying with a desired areal loading of about 20 mg/cm² for NMC811 active material but which may vary depending on the positive active material. In an aspect, this cast cathode is then calendered to achieve a target density of about 3.3-3.5 g/cm³ (for a single side of the cathode), and 3.0-3.6 g/cm³ in another aspect.

The dimensions of each cathode are about 60 mm wide by 80 mm in length. The cathodes are assembled in a stack with anodes measuring about 63 mm in width and 84 mm in length. A separator is interposed between each anode and cathode, and electrolyte is then added to the cell to complete manufacture. The assembled 8.3 Ah stack has about thirty (30) double sided cathodes with matching anodes all contained within a aluminum pouch (pouch cell). In addition to the above described 8 Ah cells, additional control pouch cells were manufactured with anode compositions matching composition cell 1 as described in Table 2.

### Example 6

Full cell testing of NMC811 Pouch Cells with Improved Anode

This example explores the cycling performance of a pouch cell format with the silicon oxide/graphite/had carbon based active materials of the improved anode described herein.

The cycling performance of the improved anode pouch cell was tested and compared against the performance of the control cell.

TABLE 4

| | Discharge Capacity @ | | Discharge Capacity | |
|---|---|---|---|---|
| | Various C Rate (Ah) | | Retention @ Various C Rate (%) | |
| | Improved | | Improved | |
| C-Rate | Anode | Control | Anode | Control |
| 0.33 | 8.3 | 7.8 | 102 | 102 |
| 0.5 | 8.2 | 7.7 | 101 | 101 |
| 1 | 8.1 | 7.5 | 100 | 100 |
| 3 | 7.9 | 7.4 | 99 | 99 |
| 5 | 7.8 | 7.3 | 98 | 98 |
| 10 | 7.7 | 7.1 | 96 | 95 |
| 15 | 7.6 | 6.9 | 96 | 90 |
| 20 | 7.5 | 5.7 | 93 | 75 |

As shown in Table 4, capacities and capacity retentions at series of C-rates performances of the about 8 Ah pouch cells comparing with and without HC addition (10 wt %) into graphite/SiOₓ (29%). Capacity retention values are calculated relative to 1 C capacity.

Significant enhancements are observed at higher rates, particularly up to 20 C. At 20 C, the incorporation of HC resulted in retaining >93% of capacity compared to the capacity at 1 C. In contrast, the control anode lacking HC retained <78% of capacity under the same conditions.

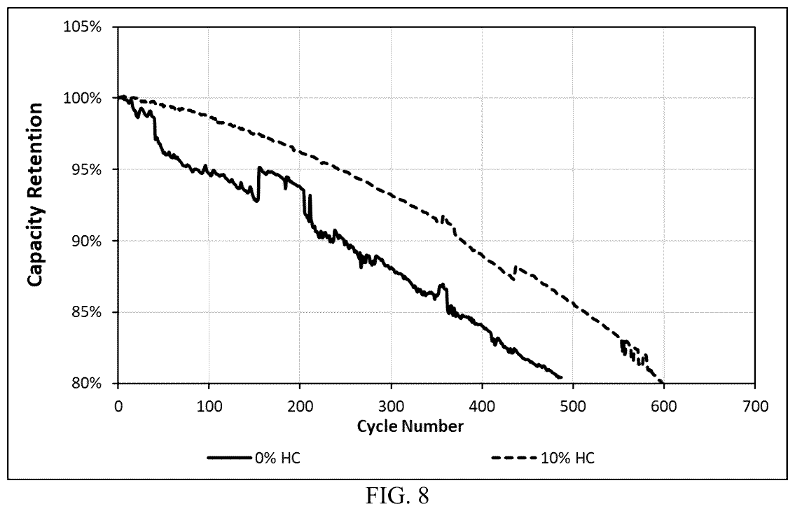

Further enhancements in cycling performance were also noted. Capacity retention vs number of cycles is shown in FIG. 8. Without HC, the cells reached 80% of their original capacity after approximately 500 cycles. With the addition of 10% HC, the cells survived 600 cycles.

To further demonstrate the enhancements observed, average discharge voltages were calculated and compared at various discharge rates for the described pouch cells. As shown in Table 5, the average discharge voltage exceeds that of the control at higher rates of discharge.

TABLE 5

| | 0.33 C | 0.5 C | 1 C | 3 C | 5 C | 10 C | 15 C | 20 C |
|---|---|---|---|---|---|---|---|---|
| 10% HC | 3.53 | 3.53 | 3.51 | 3.45 | 3.40 | 3.28 | 3.18 | 3.08 |
| Control | 3.54 | 3.53 | 3.51 | 3.43 | 3.36 | 3.21 | 3.07 | 2.97 |

In this example, the effect on electrolyte composition is determined by altering the ratio and amount of methyl acetate (MA) and fluoroethylene carbonate (FEC). Nine (9) different electrolyte solutions with a 1.5M LiPF6 salt were prepared and added to CR2032 coin cells, which further comprised: a cathode with an 21.5 mg/cm2 loading and 4.0 mAh/cm2 areal capacity, and an anode comprising at least 30% of silicon active materials.

The electrolyte compositions are shown in Table 8, along with the volume ratio of MA and FEC and the total volume percentage of the combined MA and FEC. The balance of electrolyte comprises an equal volume percentage of dimethyl carbonate (DMC) and ethyl methyl carbonate (EMC).

TABLE 8

| | | (MA + | | | | |
|---|---|---|---|---|---|---|
| Example | MA/FEC | FEC) | DMC + | | | LINEAR |
| # | vol ratio | vol % | EMC | MA | FEC | Carbonates |
| 01 | 1 | 40 | balanced | 20.0 | 20.0 | 60 |
| 02 | 2 | 60 | balanced | 40.0 | 20.0 | 40 |
| 03 | 0.5 | 30 | balanced | 10.0 | 20.0 | 70 |
| 04 | 2 | 30 | balanced | 20.0 | 10.0 | 70 |
| 05 | 0.5 | 60 | balanced | 20.0 | 40.0 | 40 |
| 06 | 3 | 43.4 | balanced | 32.6 | 10.9 | 56.6 |
| 07 | 6 | 46.7 | balanced | 40.0 | 6.7 | 53.3 |
| 08 | 0.75 | 46.7 | balanced | 20.0 | 26.7 | 53.3 |
| 09 | 0.25 | 25 | balanced | 5.0 | 20.0 | 75 |

The cells were assembled and then tested to determine the effect of the electrolyte composition on cell performance.

In a first set of tests, the cells were charged fully at a 1 C rate and then discharged at various rates up to 8 C at room temperature. Each cell's discharge capacity is shown in Table 9. The different electrolyte compositions shows a marked effect on discharge capacity, especially at higher rates of discharge. The results show that higher levels of MA improve discharge capacity across discharge rates from 0.1 C through 8 C. Although the improved capacity does not track linearly with MA volume percents, it is clear that there is improved performance when MA volume percents exceed 20%.

TABLE 9

| Example | Discharge capacity (mAh/g) | | | | | |
|---|---|---|---|---|---|---|
| # | 0.1 C | 0.33 C | 1 C | 3 C | 5 C | 8 C |
| 01 | 198.74 | 196.43 | 191.7 | 180.27 | 160.36 | 89.34 |
| 02 | 198.42 | 195.85 | 191.32 | 180.09 | 166.26 | 116.11 |
| 03 | 197.91 | 195.53 | 190.74 | 176.32 | 141.54 | 73.69 |
| 04 | 197 | 194.75 | 190.26 | 178.16 | 157.43 | 93.33 |
| 05 | 196.9 | 194.55 | 189.52 | 172.61 | 123.29 | 62.92 |
| 06 | 196.21 | 193.79 | 189.64 | 178.72 | 164.37 | 111.74 |
| 07 | 197.25 | 195.22 | 190.95 | 180.62 | 166.38 | 112.41 |
| 08 | 193.03 | 192.53 | 189.47 | 177.33 | 140.24 | 66.01 |
| 09 | 198.27 | 195.87 | 191.19 | 178.24 | 151.01 | 83.86 |

### Average Discharge Voltage is Calculated by

$$Discharge voltage = Discharge Energy ( in mWh or Wh ) / Discharge capacity ( in mAh or Ah ) at each rate .$$

The average discharge voltage for a series of discharge rates is set forth in Table 10. Again, the cells with high MA volume percents tested better and have a higher average discharge voltage across the tested discharge rates especially at lower C-rates.

TABLE 10

| Example | Average Discharge Voltage (V) | | | | | |
|---|---|---|---|---|---|---|
| # | 0.1 C | 0.33 C | 1 C | 3 C | 5 C | 8 C |
| 01 | 3.535 | 3.521 | 3.481 | 3.334 | 3.230 | 3.199 |
| 02 | 3.530 | 3.519 | 3.479 | 3.333 | 3.241 | 3.188 |
| 03 | 3.525 | 3.512 | 3.470 | 3.314 | 3.236 | 3.195 |
| 04 | 3.529 | 3.516 | 3.474 | 3.317 | 3.233 | 3.203 |
| 05 | 3.523 | 3.507 | 3.459 | 3.289 | 3.229 | 3.175 |
| 06 | 3.535 | 3.521 | 3.473 | 3.303 | 3.211 | 3.146 |
| 07 | 3.538 | 3.527 | 3.484 | 3.323 | 3.226 | 3.169 |
| 08 | 3.540 | 3.527 | 3.483 | 3.328 | 3.251 | 3.234 |
| 09 | 3.522 | 3.506 | 3.456 | 3.288 | 3.205 | 3.154 |

The batteries were charged at a 1 C rate and discharged at 3 C, 5 C and 8 C rates. A battery's capacity retention at these differing C-rates indicates how well it withstands accelerated degradation from aggressive use compared to gentler cycling. Capacity retention values at all other rates are calculated using the capacity discharge at 1 C was considered the baseline (1 C/1 C ratio=100%). As shown in Table 11 and as expected the higher C-rates generally cause more stress and faster capacity fading. However the batteries with the higher MA volume percents displayed higher capacity retention, and in some case resulted approximately 200% improved capacity relative lower MA volume percentages.

TABLE 11

| | Capacity | | |
|---|---|---|---|
| Example | Retention(%) | | |
| # | 3 C/1 C | 5 C/1 C | 8 C/1 C |
| 01 | 94.04 | 83.65 | 46.60 |
| 02 | 94.13 | 86.90 | 60.69 |
| 03 | 92.44 | 74.21 | 38.63 |
| 04 | 93.64 | 82.74 | 49.05 |
| 05 | 91.08 | 65.05 | 33.20 |
| 06 | 94.24 | 86.67 | 58.92 |
| 07 | 94.59 | 87.13 | 58.87 |
| 08 | 93.59 | 74.02 | 34.84 |
| 09 | 93.23 | 78.98 | 43.86 |

The cells were then tested for charging characteristics. The charge CC/(CC+CV) percentage refers to the proportional amount of total charging time spent at a constant current (CC) phase compared to the total charging time, which includes both the CC and a constant voltage (CV) phase. A higher ratio indicates that the battery spends more time in the CC stage, a desired outcome when prioritizing faster charging or better battery longevity by avoiding overcharging. Higher C-rates (faster charging) can lead to a shorter CC phase and a proportionally larger CV phase to safely top off the battery. The batteries were tested for charge CC/(CC+CV) percentage and the results are shown in Table 12. Again, the batteries with high MA/FEC ratios performed better—especially at higher discharge rates.

TABLE 12

| Example | Charge CC/(CC + CV) Ratio (%) | | | | | |
|---|---|---|---|---|---|---|
| # | 0.1 C | 0.33 C | 1 C | 3 C | 5 C | 8 C |
| 01 | 95.42 | 92.03 | 81.2 | 58.72 | 35.38 | 13.5 |
| 02 | 94.69 | 91.5 | 81.56 | 62.81 | 44.02 | 21.89 |
| 03 | 94.63 | 91.76 | 80.43 | 57.96 | 35.86 | 13.68 |
| 04 | 95.2 | 92.29 | 83.74 | 62.54 | 42.66 | 17.4 |
| 05 | 94.01 | 88.42 | 78.86 | 55.17 | 32.9 | 11.02 |
| 06 | 94.7 | 91.54 | 82.78 | 63.06 | 42.77 | 20.71 |
| 07 | 96.73 | 93.47 | 84.02 | 64.41 | 47.27 | 23.83 |
| 08 | 95.18 | 90.91 | 80.23 | 55.72 | 29.94 | 10.03 |
| 09 | 94.15 | 89.76 | 78.34 | 53.54 | 31.43 | 9.45 |

The average charge voltage is simply the average voltage applied to the battery during the total charge cycle. Lower average charge voltages enable a lower amount of power to charge a battery and indicate the battery is more efficiently charged. In Table 13, the average charge voltages necessary for the various discharge rates are shown. The lowest charge voltages correspond to the higher MA volume percentages and low to moderate volume ratio of FEC.

TABLE 13

| Example | Average Charge Voltage (V) | | | | | |
|---|---|---|---|---|---|---|
| # | 0.1 C | 0.33 C | 1 C | 3 C | 5 C | 8 C |
| 01 | 3.764 | 3.8144 | 3.8619 | 4.0207 | 4.114 | 4.1698 |
| 02 | 3.7546 | 3.8076 | 3.8527 | 3.997 | 4.0876 | 4.1524 |
| 03 | 3.7579 | 3.8138 | 3.8626 | 4.0222 | 4.1141 | 4.1691 |
| 04 | 3.7521 | 3.8044 | 3.8485 | 3.992 | 4.0893 | 4.1611 |
| 05 | 3.7648 | 3.8212 | 3.8728 | 4.0356 | 4.1237 | 4.1738 |
| 06 | 3.7579 | 3.8114 | 3.8552 | 3.9977 | 4.0938 | 4.156 |
| 07 | 3.7497 | 3.802 | 3.8428 | 3.9825 | 4.076 | 4.1461 |
| 08 | 3.7667 | 3.8241 | 3.8741 | 4.039 | 4.1314 | 4.1773 |
| 09 | 3.7699 | 3.8258 | 3.8818 | 4.0503 | 4.1299 | 4.1781 |

The data was again analyzed with an emphasis on the data corresponding to lower performance batteries at higher discharge rates. The following observations were made:
Example 5 and 8 cells performed poorly especially at higher rate despite having 20 volume % MA. The FEC volume % for these batteries exceeded 20% FEC.
Example 7 battery having a FEC volume of 6.7% and an MA volume of 40% performed well, as did the Example 2 battery with a combined MA and FEC volume of 60%. However, Example 5 battery also had a combined MA and FEC volume of 60%.
So, regardless of the total MA and FEC volume %, batteries with MA volume % exceeding 20% perform well, whereas batteries with FEC volume percents exceeding 20% perform relatively poorly.
After Examples 2 and 7, Examples 1, 4 and 6 performed relatively well. All five of these example have a volume ratio of MA/FEC greater than 1.0, and have FEC Vol % equal to or less than 20%.

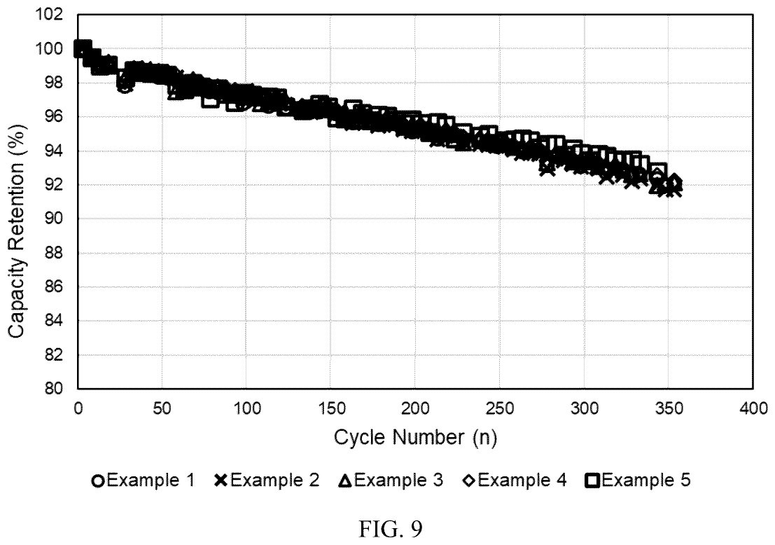

Referring to FIG. 9, which displays data showing room temperature cycling at 3 C/3 C for Examples 1-5. In FIG. 9, each 5^{th} cycle is shown for readability. The data shows that despite the large amounts of both MA and FEC, and significant improvements on both charge and discharge rate performances, the cells retain significant and comparable capacity over 350 cycles.

To summarize, the data of this Example shows that for batteries with linear carbonate electrolytes including MA and FEC, performance is influenced by the volume percents of both MA and FEC as well as the ratio of MA and FEC. Specifically, performance is improved when the volume % of MA is equal to or greater than 20%, the FEC volume % is not greater than 20%, and the MA/FEC ratio is equal to or greater than 1.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A battery comprising an electrolyte, which comprises a plurality of linear alkyl carbonates, a fluorinated solvent, and an acetate, wherein based on a total volume of the electrolyte, a volume percentage of the linear alkyl carbonate is X, the volume percentage of the fluorinated solvent is Y and a volume percentage of the acetate compound is Z, where X, Y and Z meet conditions represented by Formula (1), and Formula (2):
$$about 50 vol \% \leq ( X ) \leq about \% 70 vol \% ; and \qquad ( 1 )$$
$$about 0.8 \leq ( Z / Y ) \leq about 6. . \qquad ( 2 )$$

2. The battery according to claim 1, where Y meets conditions represented by Formula (3): (Y)≤20 vol % (3).

3. The battery according to claim 1, where Z meets conditions represented by Formula (4): 20 vol %≤(Z) (4).

4. A battery comprising an electrolyte, which comprises a plurality of linear alkyl carbonates, a fluorinated solvent, and an acetate, wherein based on a total volume of the electrolyte, a volume percentage of the linear alkyl carbonate is X, the volume percentage of the fluorinated solvent is Y and a volume percentage of the acetate compound is Z, where X, Y and Z meet conditions represented by Formula (5), and Formula (6):
$$about 0.8 \leq ( Z / Y ) \leq about 6. , \qquad ( 5 )$$
$$( Y ) \leq 20 vol \% . \qquad ( 6 )$$

5. A battery comprising an electrolyte, which comprises a plurality of linear alkyl carbonates, a fluorinated solvent, and an acetate, wherein based on a total volume of the electrolyte, a volume percentage of the linear alkyl carbonate is X, the volume percentage of the fluorinated solvent is Y and a volume percentage of the acetate compound is Z, where X, Y and Z meet conditions represented by Formula (7), and Formula (8):
$$about 50 vol \% \leq ( X ) \leq about \% 70 vol \% ; \qquad ( 7 )$$
$$and ( Y ) \leq 20 vol \% . \qquad ( 8 )$$

6. The battery according to claim 2, where Z meets conditions represented by Formula (9): 20 vol %≤(Z) (9).

7. The battery according to claim 1, wherein the linear alkyl carbonates comprises a compound of Formula (10):
$$A ( O = {C ( - O - )}_{2} ) B ; \qquad ( 10 )$$
wherein, A is a methyl group and B is either a methyl or dimethyl group.

8. The battery according to claim 1, wherein the acetate compound is selected from the group consisting of methyl acetate, ethyl acetate and vinyl acetate.

9. The battery according to claim 3, wherein the fluorinated solvent is a carbonate.

10. The battery according to claim 9, wherein the fluorinated solvent is fluoroethylene carbonate.

11. The battery according to claim 3, further comprising a negative electrode comprising from about 85 wt % to about 98 wt % of active materials.

12. The battery according to claim 3, further comprising a negative electrode having an active material, wherein the active material comprises from about 5 wt % to about 100 wt % of an active material comprising silicon.

13. The battery according to claim 12, wherein the active material comprises from about 30 to 50 wt % of an active material comprising silicon.

14. The battery according to claim 13, wherein the active material is selected from the group consisting of an active material comprising SiOₓ, an active material comprising silicon which is coated with a conductive carbon, an active material comprising carbon-encapsulated SiOₓ, and silicon carbide.

15. The battery of claim 14, wherein the negative electrode comprises a composite of the active materials and the composite is distributed throughout the anode.

16. The battery of claim 3, further comprising a cathode, wherein the cathode comprises an active material comprising a nickel-rich lithium nickel manganese cobalt oxide, wherein the nickel-rich lithium nickel manganese cobalt oxide is approximately represented by the formula LiNiₓMn_{y}Co_{z}O₂, where x+y+z≈1, 0.80≤x, 0.025≤y≤0.1, 0.025≤z≤0.1.

17. The battery of claim 3, further comprising a cathode, wherein the cathode comprises an active material comprising a nickel-rich lithium nickel manganese cobalt oxide, wherein the nickel-rich lithium nickel manganese cobalt oxide is approximately represented by the formula LiNiₓMn_{y}Co_{z}O₂, where LiNiₓMn_{y}Co_{z}O₂, where x+y+z≈1, 0.6≤x, 0.025≤y≤0.2, 0.025≤z≤0.2.

18. The battery of claim 17, wherein the active material comprising silicon is coated with a conductive carbon.

19. The battery of claim 17, wherein the active material comprising silicon includes carbon-encapsulated SiOₓ.

20. The battery of claim 3, further comprising a separator, wherein the separator is polymeric and has a porosity greater than 40%.

21. The battery of claim 20, wherein the separator is ceramic coated.

22. The battery of claim 3, wherein the electrolyte comprises at least one salt selected from a group consisting of LiPF₆, LiBF₄, LiFSI, and LiTFSI.

23. The battery of claim 22, where the electrolyte comprises a total concentration of generally 1-2 M of the lithium salts.

24. The battery of claim 22, wherein the electrolyte comprises a combination of additives selected from a group comprising VC, FEC, DTD, PS, LiODFP, LiODFB, LiPO₂F₂, TMSP, flame retardant additives and compound of formula (11): 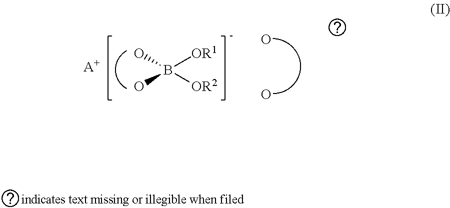
wherein: A⁺ is selected from the group consisting of Li⁺, Na⁺, K⁺, Cs⁺, and ammonium;
wherein 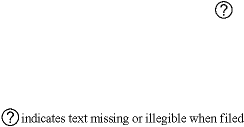
is a bidentate radical derived from a (hetero)aromatic 1,2-, 1,3- or 1,4-diol, from a (hetero)aromatic 1,2-, 1,3- or 1,4-dicarboxylic acid or from a (hetero)aromatic 1,2-, 1,3- or 1,4-hydroxycarboxylic acid by abstracting the two H atoms of pairs of adjacent OH groups; and R¹ and R² are independently selected from the group consisting of C₁ to C₁₀ alkyl, C₂ to C₁₀ alkenyl, C₂ to C₁₀ alkynyl, C₃ to C₁₀ cycloalkyl, and C₅ to C₁₄ (hetero)aryl, wherein alkyl, alkenyl, alkynyl, cycloalkyl, and (hetero)aryl may be substituted by one or more substituents selected from F, CN, and optionally fluorinated groups selected from a group consisting of C₁ to C₄ alkyl, C₂ to C₄ alkenyl, C₂ to C₄ alkynyl, phenyl, and benzyl.

25. The battery of claim 1, wherein the battery has a capacity of at least about 3 Ah, when operated at a charge cutoff voltage range of 4.2 to 4.5V, a discharge cutoff voltage range of 2.5 to 3.0V, and a minimum cycling rate range of 1 C to 10 C.

26. The battery of claim 1, wherein the cell maintains at least 80% of its first cycle capacity after 500 cycles at 3 C discharge and 3 C charge rates at room temperature (25° C.).

27. The battery of claim 1, wherein cell discharge at 20 C rate retains at least 90% of capacity relative to cell discharge at 1 C rate at room temperature.
